(19) United States
(12) Patent Application Publication
(10) Pub. No.: US 2005/0088461 A1
(43) Pub. Date: Apr. 28, 2005

(54) Method and apparatus for selectively changing the brightness level of a portion of a screen in a data processing system

(75) Inventor: Kulvir S. Bhogal, Fort Worth, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/692,167

(22) Filed: Oct. 23, 2003

(51) Int. Cl. G09G 5/10

(52) U.S. Cl. 345/690

(57) ABSTRACT

A method, apparatus, and computer instructions for selectively increasing illumination of a region on a screen. A display intensity of the screen is altered within the region in response to identifying the region on the screen. The display intensity of the screen within the region is greater than other portions of the screen. A determination is made as to whether the region has been redefined. In response to the region being redefined to form a redefined region, the display intensity of the screen is altered within the redefined region.

### BACKGROUND OF THE INVENTION

1. Technical Field

The present invention relates generally to an improved data processing system and in particular to a method and apparatus for managing a data processing system. Still more particularly, the present invention relates to a method, apparatus, and computer instructions for managing brightness on selected portions of a screen in a data processing system.

2. Description of Related Art

Laptop computers and other mobile computing devices have become popular because these devices allow users to perform work and access data without being tied to a specific location. Further, these mobile computing devices also provide for connectivity to networks and the Internet through wireless communications links.

A laptop computer or other mobile computing device typically has a flat screen using a liquid crystal display. Additionally, these systems use batteries for mobile use and an AC power supply to charge the batteries or for desktop use when the laptop computer is located near a power outlet. Battery life is of great interest with respect to users of laptop computers. Battery life typically ranges from about two hours to five hours depending on the particular type of system. Drains on the battery involve devices, such as hard disk drives, processors, and LCD screens.

Currently, power conservation systems are present for controlling hard disk drives, processors, and displays. Hard disk drives may be powered down after some amount of time passes without accessing the drive. Further, when a processor on a laptop is not in use or if the application requires less power from the processor, the processor may be slowed down to a slower speed to reduce the use of power. LCD displays in laptop computers are well known for being consumers of much of the battery in the laptop. A common function provided on many laptops is an ability to dim or reduce the intensity of lighting for the laptop screen when the laptop is running on batteries. However, in many cases, when a laptop computer is using battery power, the reduced intensity of the screen may make it difficult for the user to view items of interest on the screen. Running the screen at full intensity, however, would drain the battery much quicker than desired by the user.

Therefore, it would be advantageous to have an improved method, apparatus, and computer instructions for managing the display of data on a screen on a laptop computer.

### SUMMARY OF THE INVENTION

The present invention provides a method, apparatus, and computer instructions for selectively increasing illumination of a region on a screen. A display intensity of the screen is altered within the region in response to identifying the region on the screen. The display intensity of the screen within the region is greater than other portions of the screen. A determination is made as to whether the region has been redefined. In response to the region being redefined to form a redefined region, the display intensity of the screen is altered within the redefined region.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in the form of a laptop computer in which the present invention may be implemented;

FIG. 2 is a block diagram of a data processing system in which the present invention may be implemented;

FIG. 3 is a diagram illustrating components used in selectively changing the display intensity of a portion of a display in accordance with a preferred embodiment of the present invention;

FIGS. 4A and 4B are illustrative examples of a display using a selective illumination feature in accordance with a preferred embodiment of the present invention;

FIG. 5 is a display of screens illustrating a selective illumination feature in accordance with a preferred embodiment of the present invention;

FIG. 6 is a flowchart of a process for defining an illumination feature in accordance with a preferred embodiment of the present invention; and

FIG. 7 is a flowchart of a process for selectively changing the display intensity of a selected portion of a screen in accordance with a preferred embodiment of the present invention.

### DETAILED DESCRIPTION OF THE PREFERRED EMBODIMENT

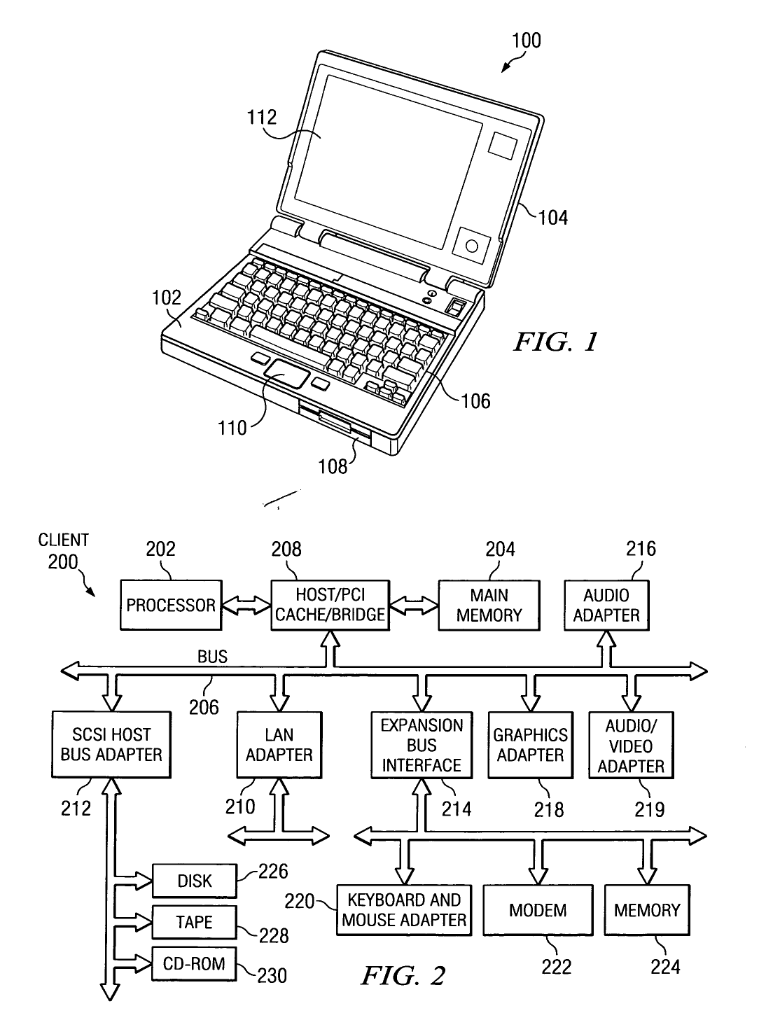

With reference now to the figures and in particular with reference to FIG. 1, a pictorial representation of a data processing system in the form of a laptop computer is shown in which the present invention may be implemented. Laptop computer 100 is illustrated as including a base unit 102 and a display unit 104. Base unit 102 contains keyboard 106 as well as storage devices, such as compact disk (CD) drive 108. Additionally, pointing device 110 is present in base unit 102. In this example, pointing device 110 takes the form of a touch pad. Base unit 102 also contains other storage devices, such as a hard disk drive. Display unit 104 in this example includes liquid crystal (LCD) display 112, which is an active matrix LCD screen in this example. Further, base unit 102 may provide for expansion through slots for PC cards or have bays for additional drives or batteries.

Further, base unit 102 may include an interface to connect laptop computer 100 to a docking station to provide for connection to additional devices. Laptop computer 100 may be implemented using any suitable laptop or notebook computer, such as a ThinkPad A Series from International Business Machines Corporation.

The present invention provides a method, apparatus, and computer instructions for selectively changing the brightness or intensity level of selected portions of display 112. In particular, when display 112 is dimmed or in a power saving mode when laptop computer 100 is using battery power, portions of display 112, such as an area around a pointer or within an active window may be displayed at a brighter or greater intensity to allow for easier viewing of items of interest to the user. The mechanism ties the location of a pointer to the amount of illumination as well as to an active window in these illustrative embodiments.

With reference now to FIG. 2, a block diagram of a data processing system is shown in which the present invention may be implemented. Data processing system 200 is an example of a computer, such as laptop computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202.

Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection.

In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides an improved method, apparatus, and computer instructions for selectively increasing the display intensity or illumination of selected portions of a display, such as a liquid crystal display. This increase in illumination or intensity is associated with the location of a pointer or an active window in the illustrative embodiments. The mechanism of the present invention allows the user to specify a section of the display, such as an area around a pointer to be displayed with normal brightness, rather than the diminished brightness when a laptop computer is using battery power.

After the area is defined, the display driver may send a lower brightness to the area not belonging within the defined area. Alternatively, a higher brightness indication or signal may be sent for the defined area to increase the intensity, depending on the particular implementation. In this manner, an active window or the area defined around a pointer may be shown with an increased intensity while the rest of the screen is shown with less intensity. In this manner, the battery power may be conserved while still allowing a user to see a portion of the screen in which items of interest are located.

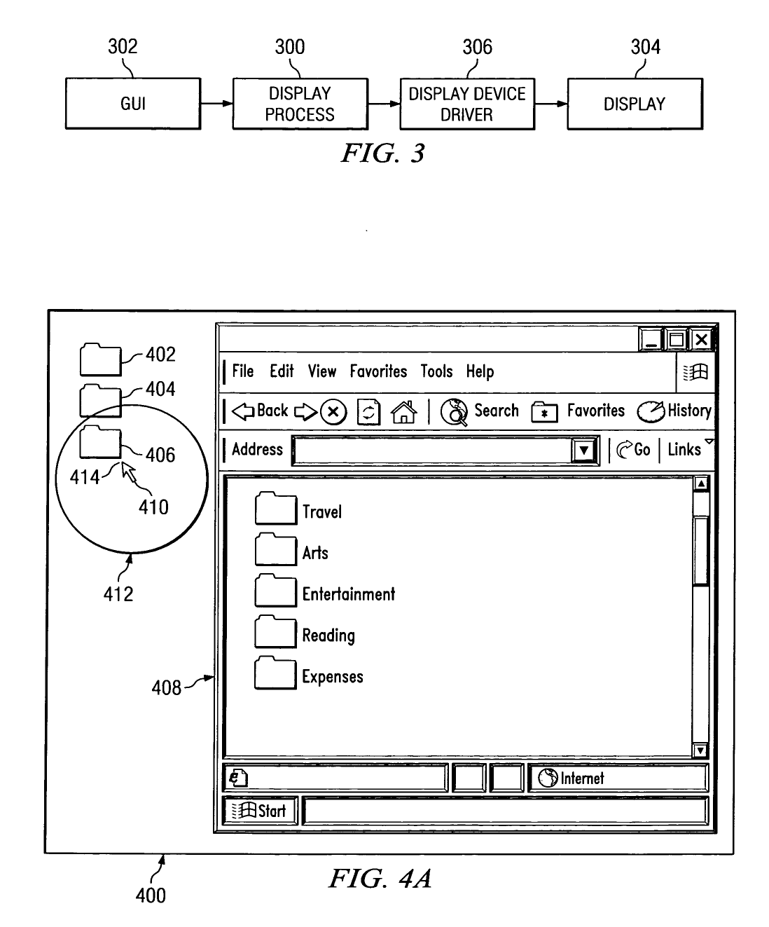

With reference now to FIG. 3, a diagram illustrating components used in selectively changing the display intensity of a portion of a display is depicted in accordance with a preferred embodiment of the present invention. Display process 300 may receive user input through graphical user interface (GUI) 302. The user input received may set parameters for display process 300 to selectively increase or decrease the illumination of portions of display 304 by sending the appropriate signals to display device driver 306. Display device driver 306 is a program routine that links the operating system to a display device, such as an LCD display. This particular component will send the appropriate signals to the display device, such as a display adapter for the LCD display to change the display intensity for different regions on the screen in the display device.

For example, a region of normal or higher brightness may be defined as some region around a pointer. Alternatively, the region of higher or normal intensity may be defined as that of an active window. The region around a pointer may be defined through graphical user interface 302. This region may be some parameter having a shape, such as a circle, square, or some other polygon in which the region around the pointer is displayed with a higher intensity than the rest of the screen in display 304. The different intensity display signals are generated by display device driver 306 in response to the regions defined by display process 300.

Thus, as the pointer moves from one area of display 304 to another area of display 304, the intensity of the display changes within a region around the pointer as the pointer moves within display 304. As the pointer moves, the region is redefined around the pointer in the new location. In this manner, the items of interest to a user may be identified through the focus of the pointer with those items being displayed with a greater intensity than other portions of the screen. In another illustrative embodiment, an active window may be displayed with a greater intensity than other portions of the screen in display 304.

The display adapter for display 304 may include circuitry to increase the amplitude of pixels identified by display device driver 306 as requiring a greater intensity. This type of circuitry and mechanism may be implemented using the system described in PCT Application No. WO 02/059732 A1, Window Brightness Enhancement for LCD Display.

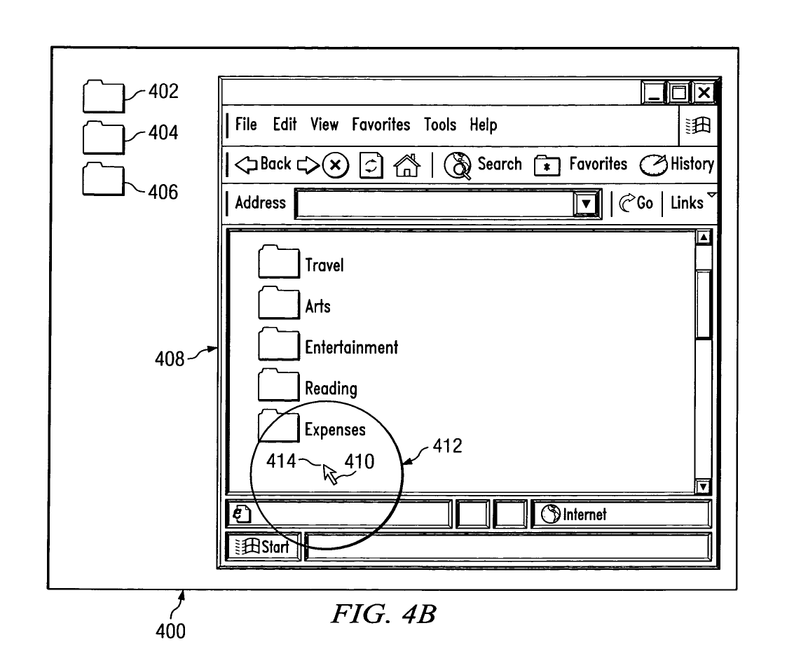

Turning now to FIGS. 4A and 4B, illustrative examples of a display using a selective illumination feature is depicted in accordance with a preferred embodiment of the present invention. In FIG. 4A, screen 400 contains folders 402, 404, and 406. In addition, window 408 is displayed within screen 400. In this example, pointer 410 includes a region 412 around pointer 410. Hot spot 414 is in the center of region 412. Screen 400 is in a dim or low intensity state except for the area within region 412 of screen 400. This portion of screen 400 is displayed at a higher level of intensity or brightness than the rest of screen 400. Thus, when pointer 410 is moved, as shown in FIG. 4B, region 412 also moves. In this manner, the user may illuminate or increase the intensity of display of portions of screen 400 for items or areas of interest by moving pointer 410.

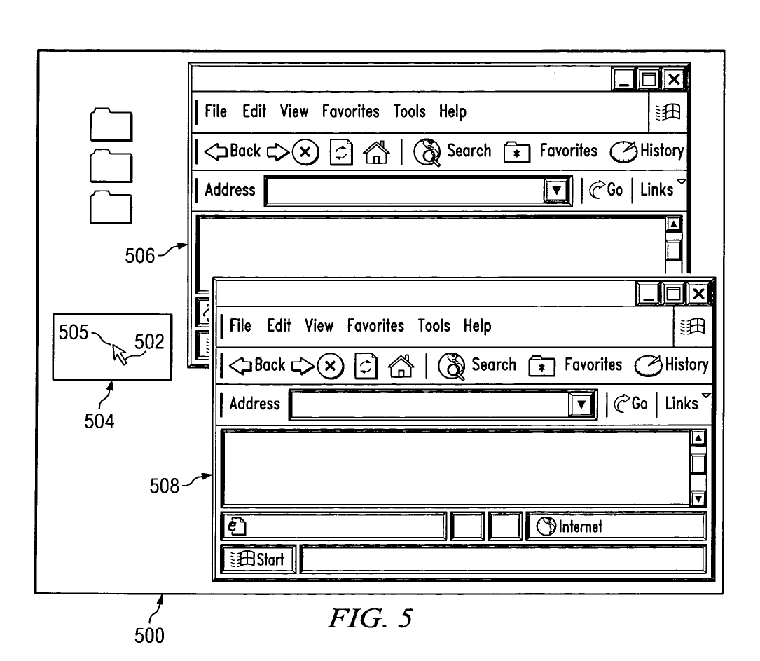

Turning next to FIG. 5, a screen illustrating a selective illumination feature is depicted in accordance with a preferred embodiment of the present invention. In this example, screen 500 contains pointer 502 surrounded by region 504, which is centered around hot spot 505. As depicted, region 504 takes the shape of a rectangle. Of course, any shape or polygon may be used to define region 504 depending on the particular implementation.

Alternatively, the selective change in intensity of display may be based on an active window. In this example, active window 506 is the active window, while window 508 is the inactive window. In such an illustrative embodiment, region 504 is not used. Instead, the region of screen 500 within active window 506 is displayed in a higher level of intensity than the rest of screen 500. Active window 506 is the focus of attention and is provided with a higher level of display brightness to provide for easier viewing for the user. Further, region 504 may be employed to provide for a higher level of display intensity within region 504 as well as providing for a higher level of display intensity for active window 506 within screen 500.

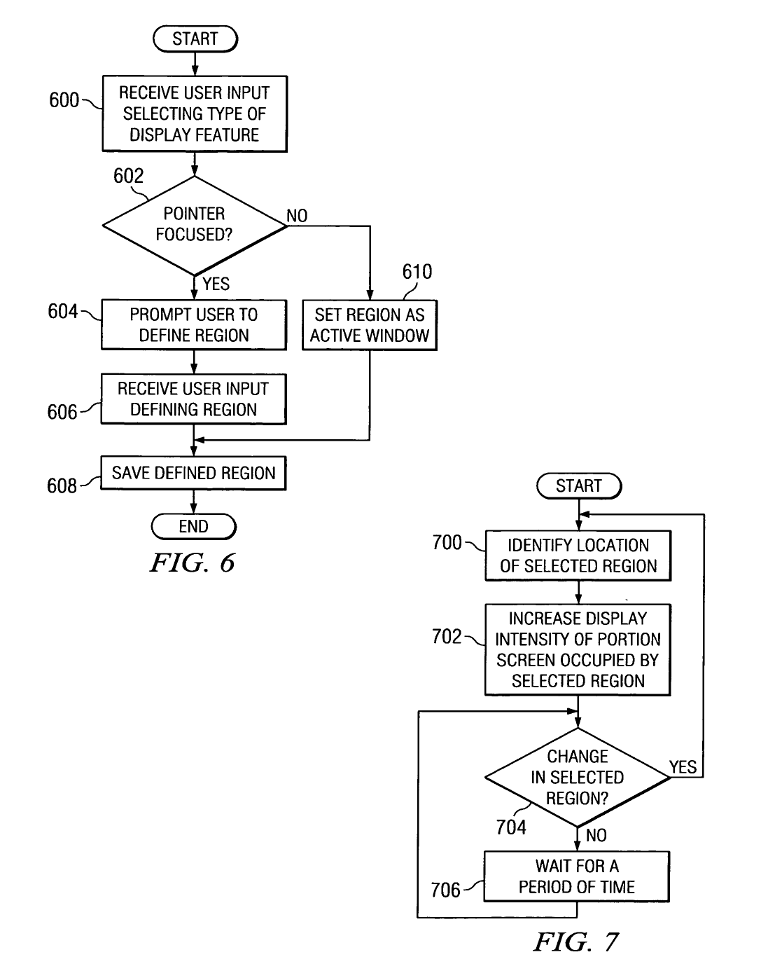

Turning now to FIG. 6, a flowchart of a process for defining an illumination feature is depicted in accordance with a preferred embodiment of the present invention. The process illustrated in FIG. 6 may be implemented in a display process, such as display process 300 in FIG. 3.

The process begins by receiving a user input that selects a type of display feature (step 600). A determination is made as to whether the display feature is pointer focused (step 602). If the display feature is to be focused around a pointer, the user is prompted to define the region (step 604). User input defining the region is then received (step 606). This user input may define the region shape. For example, the shape may be a circle, a square, a rectangle, or some other polygon. Further, some user-defined region drawn by the user may be used also. In yet another illustrative embodiment, this region may be defined as some number of lines above and below a line in a document containing an I-bar, which is a cursor indicating an insertion point in a document. In this example, the region is focused around an I-bar and also may be some number of lines above and below an I-bar, such as two lines above the location of the I-bar and two lines below the location of the I-bar in the document. As a result, the defined region is some number of lines in a document within a window. The defined region is then saved (step 608) with the process terminating thereafter.

With reference again to step 602, if the display feature is not pointer focused, then the region is set as an active window (step 610). In this manner, the display intensity of the screen display for an area containing an active window is increased with respect to the rest of the screen. The process proceeds to step 608 as described above.

With reference now to FIG. 7, a flowchart of a process for selectively changing the display intensity of a selected portion of a screen is depicted in accordance with a preferred embodiment of the present invention. The process illustrated in FIG. 7 may be implemented in a display process, such as display process 300 in FIG. 3.

The process begins by identifying a location of the selected region (step 700). This selected region may take various forms, such as, for example, region 412 in FIGS. 4A and 4B or region 504 in FIG. 5. Further, the selected region also may be an active window, such as window 506 in FIG. 5. As an additional illustrative example, this region may be some number of lines above and below the location of an I-bar in a document. The display intensity of the portion of the screen occupied by the selected region is increased relative to the rest of the screen (step 702). In these examples, the display of these portions of the screen may be set at a higher intensity level than the other portions of the screen. As a result, the area of the screen encompassed by the selected region is displayed at an intensity that is easier to view by a user.

Next, a determination is made as to whether the selected region has been redefined (step 704). This redefining of a region may be, for example, the change in location of the selected region based on a movement of the mouse pointer (if a pointer focused region feature has been selected). In another illustrative embodiment, the selected region may be redefined as a change in which window is the active window. One window may become inactive while another window becomes active based on a user input or based on some processor application changing the active window. In this case, the region is redefined as the new active window. If the selected region has been redefined, the process returns to step 700 as described above. Otherwise, the process waits for a period of time (step 706) and then returns to step 704 to see whether a change in the region has occurred.

Thus, the present invention provides an improved method, apparatus, and computer instructions for selectively changing the display intensity of selected portions of a screen. The mechanism of the present invention ties the increased intensity in display to the location of a pointer or to an active window in the illustrative embodiments. This mechanism allows for decreased power usage because the intensity of display for portions of the screen other than a selected region are displayed using a lower intensity while only the portion of the screen within the selected region is displayed at a higher intensity. In this manner, the usage of power with respect to displaying information on the screen is reduced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for selectively increasing illumination of a region of a screen, the method comprising:
responsive to identifying a region on the screen, altering a display intensity of the screen within the region, wherein the display intensity of the screen within the region is greater than regions portions of the screen;
determining whether the region has been redefined; and
responsive to the region being redefined to form a redefined region, altering the display intensity of the screen within the redefined region.

2. The computer implemented method of claim 1, wherein the region is in a first location and wherein the redefined region is in a second location.

3. The computer implemented method of claim 1, wherein the region is associated with a pointer and wherein the determining step comprises:
determining whether the pointer has moved to a new location on the screen, wherein movement of the pointer to the new location results in movement of the region to the new location to form the redefined region.

4. The computer implemented method of claim 1, wherein the region is defined by an active window and wherein the determining step comprises:
determining whether a new window has become the active window, wherein the new window becoming the active window results in the region being redefined to form the redefined region.

5. The computer implemented method of claim 1, wherein the region has a shape selected from one of a circle, a square, or a rectangle.

6. The computer implemented method of claim 1, wherein the region is defined by a window displayed on the screen or by a number of lines above and below an I-bar in a document.

7. A data processing system for selectively increasing illumination of a region of a screen, the data processing system comprising:
a bus system;
a communications unit connected to the bus system;
a memory connected to the bus system, wherein the memory includes a set of instructions; and
a processing unit connected to the bus system, in which the processing unit executes the set of instructions to identify a region on the screen, alter a display intensity of the screen within the region, in which the display intensity of the screen within the region is greater than other regions of the screen, determine whether the region has been redefined, and alter the display intensity of the screen within the redefined region, in response to the region being redefined to form a redefined region.

8. A data processing system for selectively increasing illumination of a region of a screen, the data processing system comprising:
altering means, responsive to identifying a region on the screen, for altering a display intensity of the screen within the region, wherein the display intensity of the screen within the region is greater than other regions of the screen;
first determining means for determining whether the region has been redefined; and
second altering means, responsive to the region being redefined to form a redefined region, for altering the display intensity of the screen within the redefined region.

9. The data processing system of claim 8, wherein the region is in a first location and wherein the redefined region is in a second location.

10. The data processing system of claim 8, wherein the determining means is a first determining means and wherein the region is associated with a pointer and wherein the determining means comprises:
second determining means for determining whether the pointer has moved to a new location on the screen, wherein movement of the pointer to the new location results in movement of the region to the new location to form the redefined region.

11. The data processing system of claim 8, wherein the determining means is a first determining means and wherein the region is defined by an active window and wherein the determining means comprises:
second determining means for determining whether a new window has become the active window, wherein the new window becoming the active window results in the region being redefined to form the redefined region.

12. The data processing system of claim 8, wherein the region has a shape selected from one of a circle, a square, or a rectangle.

13. The data processing system of claim 8, wherein the region is defined by a window displayed on the screen or by a number of lines above and below an I-bar in a document.

14. A computer program product in a computer readable medium for selectively increasing illumination of a region of a screen, the computer program product comprising:
first instructions, responsive to identifying a region on the screen, for altering a display intensity of the screen within the region, wherein the display intensity of the screen within the region is greater than other regions of the screen;
second instructions for determining whether the region has been redefined; and
third instructions, responsive to the region being redefined to form a redefined region, for altering the display intensity of the screen within the redefined region.

15. The computer program product of claim 14, wherein the region is in a first location and wherein the redefined region is in a second location.

16. The computer program product of claim 14, wherein the region is associated with a pointer and wherein the third instructions comprises:
sub-instructions for determining whether the pointer has moved to a new location on the screen, wherein movement of the pointer to the new location results in movement of the region to the new location to form the redefined region.

17. The computer program product of claim 14, wherein the region is defined by an active window and wherein the third instructions comprises:
sub-instructions for determining whether a new window has become the active window, wherein the new window becoming the active window results in the region being redefined to form the redefined region by region.

18. The computer program product of claim 14, wherein the region has a shape selected from one of a circle, a square, or a rectangle.

19. The computer program product of claim 14, wherein the region is defined by a window displayed on the screen or by a number of lines above and below an I-bar in a document.
